(19) United States
(12) Patent Application Publication
(10) Pub. No.: US 2008/0047786 A1
(43) Pub. Date: Feb. 28, 2008

(54) Fluid cooled wet brake system

(75) Inventors: Stan Nowak, Balcatta (AU); Dorota Kieronska, Balcatta (AU); Vin Morley, Balcatta (AU)

Correspondence Address: SEED INTELLECTUAL PROPERTY LAW GROUP PLLC, 701 FIFTH AVE, SUITE 5400, SEATTLE, WA, 98104, US

(73) Assignee: Safe Effect Pty Ltd, Balcatta (AU)

(21) Appl. No.: 11/526,066

(22) Filed: Sep. 22, 2006

Related U.S. Application Data
(63) Continuation of application No. 10/559,363.

(30) Foreign Application Priority Data
Jun. 6, 2003 (AU) 2003902857

(51) Int. Cl. F16D 65/78

(52) U.S. Cl. 188/71.6

(57) ABSTRACT

Fluid cooled wet brake system comprises a sealed housing containing a volume of lubricating oil, a disc disposed in the housing and adapted for fixing to a rotating body such as a wheel hub, and one or more stators. The stators are rotationally fixed but slidably mounted within the housing and can be pushed into contact with respective braking surfaces of the discs by conventional brake pistons. The stators are provided with a fluid inlet, a fluid outlet and one or more fluid flow paths extending between the inlet and the outlet through which a cooling fluid flows.

### BACKGROUND

1. Technical Field

The present invention relates to a fluid cooled wet brake system.

2. Description of the Related Art

Wet brake systems are characterized by a sealed housing enclosing a braking surface which is coupled to a rotating body such as a wheel hub, and friction pads which can be forced into engagement with the braking surface. A volume of oil is contained in the housing providing lubrication between the pads and the braking surface. When the brake is applied, the pads are forced against the braking surface to provide a braking effect with any oil between the pads and the braking surface being expelled. The provision of oil greatly reduces the wear on the pads and the braking surface. Examples of wet brake systems are provided in Applicant's International applications published under numbers WO 93/07402, WO 96/07034, WO 02/23060 and WO 02/10606.

It has hitherto been assumed that cooling of wet brake systems was not necessary as cooling is provided by the oil contained within the housing. However the present Applicant has discovered that notwithstanding the provision of oil within the wet brake system, brake temperatures may still reach levels which significantly degrade brake performance.

A seemingly obvious solution to this is to pump the oil of the wet brake system through a radiator or other heat exchanger. However it must be appreciated that in order to provide optimum performance, the volume of oil within a wet brake system is only a fraction of the volume defined by the housing containing the braking surface and friction pads. The remainder of the volume is occupied by air. The presence of a large volume of air creates difficulties in pumping the oil through the heat exchanger. In theory, this could be rectified by completely filling the housing with oil however were this to occur, then it would not be possible to expel the oil between the friction pads and the braking surface during a braking operation in which case the brakes are unlikely to provide sufficient stopping power.

### BRIEF SUMMARY

According to the present invention there is provided a fluid cooled wet brake system comprising:

a sealed housing containing a lubricating liquid;

a disc disposed in the housing and adapted for fixing to a rotating body projecting into the housing, the disc having first and second opposite planar surfaces; friction material attached to the first planar surface;

a first stator slidably mounted and rotationally fixed within the housing and having a first braking surface facing the first planar surface, the first stator provided with a fluid inlet, a fluid outlet, and one or more internal fluid flow paths extending between the fluid inlet and the fluid outlet through which a cooling fluid flows; and,

an actuator for selectively applying a force on the first stator to slide the first stator towards the disc and hold the braking surface against the friction material.

Preferably, the friction material is in the form of one or more pads of friction material detachably coupled to the disc.

Preferably, the pads are circumferentially spaced apart about the disc.

Preferably, the wet brake system further comprises a second stator having a second braking surface facing the second planar surface and wherein the friction material is attached to the second planar surface, with the second braking surface facing the friction material on the second planar surface, and wherein the actuator selectively applies force on the second stator to slide the second stator toward the disc and hold the second braking surface against the friction material on the second planar surface.

Preferably, each stator is provided with a plurality of parallel fluid flow paths that extend between the fluid inlet and the fluid outlet.

Preferably, each stator comprises a first annular plate provided with a plurality of channels on one side, and a second annular plate attached to the one side for covering the channels wherein the covered channels form the internal fluid flow paths.

Preferably, the braking system further comprises a mechanism that slidably couples each stator to said housing.

Preferably, each pad is provided with grooves on its surface, where each groove opens at its opposite ends onto an edge of the pad.

In an alternate embodiment, the braking surfaces are provided with grooves which extend between, and open at their opposite ends, onto respective inner and outer edges of the braking surface.

Preferably, the grooves follow a spiroidal curve.

### BRIEF DESCRIPTION OF THE SEVERAL VIEWS OF THE DRAWINGS

An embodiment of the present invention will now be described by way of example only with reference to the accompanying drawings in which:

FIG. 1 is a transverse section view of an embodiment of the fluid cooled wet brake system;

FIG. 2 is a plan view of a component of a stator incorporated in the wet brake system;

FIG. 3 is a section view of a stator incorporated in the wet brake system;

FIG. 4 is a front view of a disc incorporated in the wet brake system; and,

FIG. 5 is a section view of the disc shown in FIG. 4.

### DETAILED DESCRIPTION

Referring to the accompanying drawings a fluid cooled wet brake system 10 in accordance with an embodiment of the present invention comprises a sealed housing 12 that contains a volume of lubricating liquid such as oil (not shown) and a disc 14 disposed in the housing 12 and adapted for fixing to a rotating body, such as a wheel hub 16 (only a part of which is depicted) disposed in the housing 12. The disc 14 has first and second opposite planar surfaces 18 and 20. Friction material in the form of separate friction pads 22 are attached to the first planar surface 18 of the disc 14. A first stator 24a is slidably mounted and rotationally fixed within the housing 12 and has a first braking surface 26a that faces the first planar surface 18. The first stator 24a is provided with a fluid inlet 28, a fluid outlet 30 and one or more internal fluid flow paths 32 that extend between the fluid inlet 28 and the outlet 30 and through which a cooling fluid such as water or glycol flows. An actuator comprising a set of pistons 34 is held within the housing 12 for selectively applying force on the first stator 24a to slide the stator 24a toward the disc 14 and hold the braking surface 26a against the friction pads 22.

The cooling fluid flowing through the fluid flow paths 32 can be passed through a radiator or other heat exchanger (not shown) to effectively transfer heat away from the stator 24a and friction pads 22.

In the present illustrated embodiment, the system 10 further comprises a second stator 24b which is identical to the first stator 24a but faces the second opposite side 20 of the disc 18. A further set of pistons 34 selectively apply force to the second stator 24b to slide it toward the disc 14 and hold its corresponding second braking surface 26b against friction material in the form of pads 22 fixed to the second surface 20 of the disc 14. It is envisaged that all of the pistons 34 will operate together and thus when the brake is applied, the pistons would force the stators 24a and 24b against friction pads 22 on opposite sides of the disc 14 effectively sandwiching the disc 18.

It should be appreciated that in this embodiment the friction pads 22 are attached to the rotating disc 14 while the stators 24a and 24b are rotationally fixed. This is a reversal from the typical arrangement in a wet (or indeed a dry) brake system where the friction material is rotationally fixed and the braking surfaces are the surfaces of a rotating disc, or rotor.

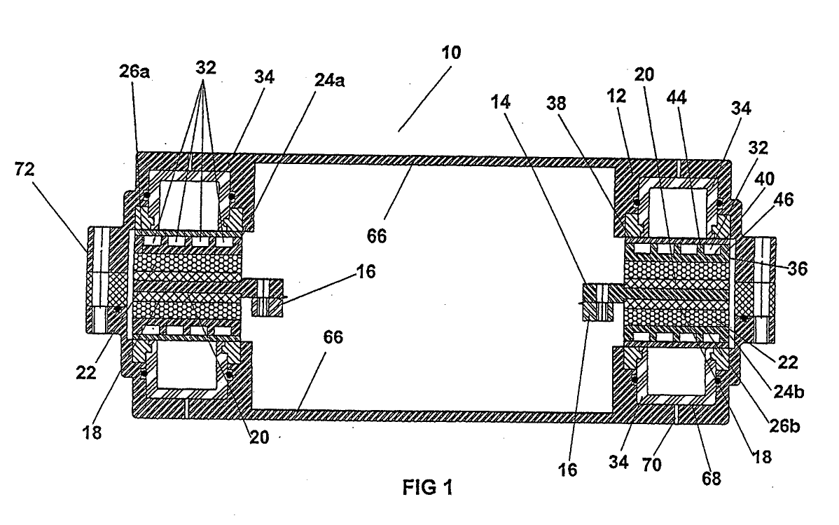

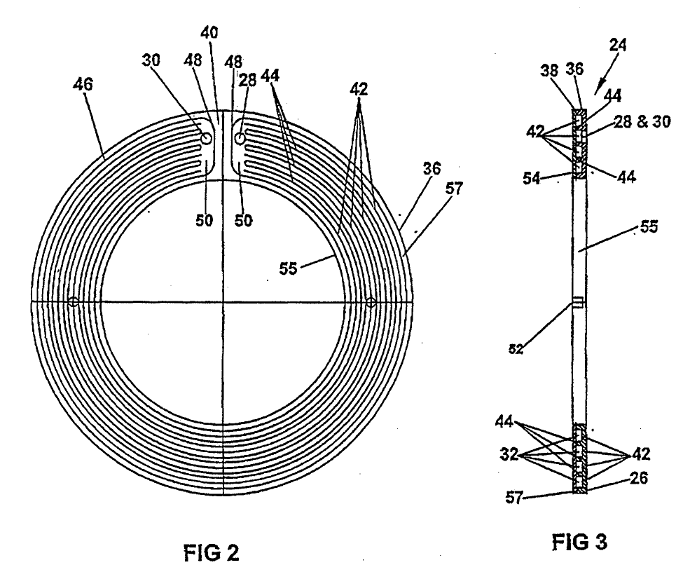

With particular reference to FIGS. 1-3, it can be seen that each of stators 24a and 24b (hereinafter referred to in general as “stators 24”) is in the form of an annular disc comprising the ensemble of a first annular plate 36 and a second annular plate 38. The first plate 36 is formed with a plurality of concentric arcuate channels 42 which extend for approximately 340° about a radial face 40 of a first plate 36. Concentrically adjacent channels 42 are separated by ribs 44. The channels 42 as well as the fluid inlet 28 and fluid outlet 30 are bound by a peripheral wall 46 which extends circumferentially about the radial face for approximately 350°. The wall 46 includes two radially extending wall portions 48. Opposite ends of the ribs 44 are spaced from the wall portions 48 so as to define respective distribution channels 50 in the general region between the wall portions 48 and adjacent ends of the ribs 44. The fluid inlet 28 is provided in one of the distribution channels 50 with the outlet 30 provided in the other distribution channel 50.

The second plate 38 has planar opposite faces and is attached to the first plate 36 over the face 40 to cover, and indeed substantially seal, the channels 42 to thereby define the internal fluid flow paths 32.

As the stators 24 are rotationally fixed, hoses can be readily coupled to the inlet 28 and outlet 30 to couple the fluid flow paths 32 to a cooling circuit which may include a reservoir of cooling fluid such as water or glycol, a heat exchanger and a pump. Cooling fluid entering through the inlet 28 is distributed by the adjacent distribution channel 50 so as to flow through each of the channels 40 and flow out of the outlet 30.

A pair of pins 52 extend axially at diametrically opposed locations from an outer radial surface 54 of the second plate 38 for location in corresponding holes (not shown) formed in the housing 12. The surface 54 forms an outer radial surface of a stator 24. The pins co-axially locate the stators 24 with the disc 14 and allow the stators 24 to slide axially but remain rotationally fixed.

Each of the stators 24 thus has planar opposite radial surfaces 26 and 54 with sealed inner and outer circumferential surfaces 55 and 57 respectively.

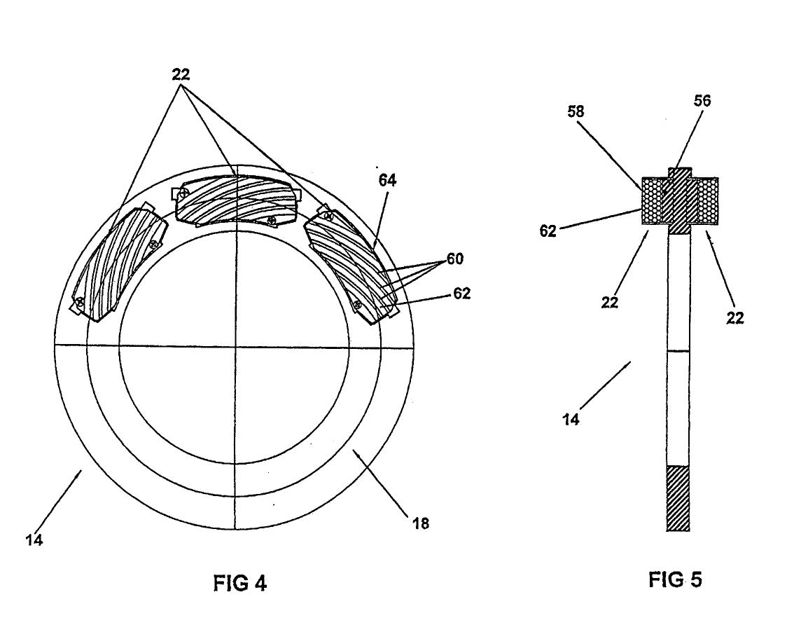

The disc 14 which is attached to the wheel hub 16 is in the form of an annular plate and, in this embodiment, has attached to its opposite surfaces 18 and 20 a plurality of friction pads 22. Referring to FIGS. 4 and 5, the friction pads 22 are of generally conventional construction comprising a backing plate 56 and a bonded layer of friction material 58. However, the pads 22 are also provided with a plurality of grooves 60 on their surface 62. Each groove 60 opens at its opposite ends onto an edge 64 of its corresponding pads 22. The grooves 60 assist in channeling oil in the wet brake system 10 from between the pads 22 and the stators 24. Ideally, the grooves 60 follow a spiroidal path.

In a variation (which is not shown) similar grooves may be formed on the surfaces 26a and 26b of the stators 24a and 24b. These grooves would extend between radially inner and outer edges of each stator 24a and 24b and again provide a channeling effect for the oil within the wet brake system. In yet a further variation, such grooves may be provided on both the surfaces 26a and 26b and the surface 62 of the friction pads 22.

The housing 12 is formed of two annular shells 66 that are fastened together by bolts. Each shell 66 includes recesses 68 defining cylinders for housing the pistons 34. Hydraulic brake fluid inlets 70 are formed in each shell 66 leading to the recesses 68 to supply hydraulic fluid for exerting pressure on the pistons 34 to activate the brakes. Each shell 66 is also formed with a central hole (not shown) to allow, on one side of the housing, for an axle casing to project into the housing, and on the other side, for a wheel hub and associate wheel studs, to project from the housing 12. Conventional seals (not shown) are provided within and/or about the central holes in the shells 66 to prevent the lubricating liquid of the wet brake system escaping from between the shells and the axle casing and wheel hub. Indeed, in the present embodiment, the housing 12 is similar to a conventional housing of a wet brake system previously designed by the Applicant but has been provided with an annular spacer 72 located between the shells 66.

The operation of the wet brake system 10 will now be briefly described.

In the wet brake system 10 the housing 12 is coupled to an axle casing (not shown) of a vehicle with the hub 16 attached to an axle disposed in the axle casing and fastened by bolts to the disc 14. A wheel (not shown) is attached to wheel studs (not shown) projecting from the hub on an opposite side of the housing 12. A small volume of lubricating liquid such as oil is held within the housing. The volume of lubricating liquid within the housing 10 is arranged so that a portion of the disc 14 passes through the oil as it rotates. This oil provides lubrication between the discs 14 and the stators 24. A supply of cooling fluid is coupled to the fluid inlet 28 and outlet 30 of the stators 24. This fluid flows through the fluid flow paths 32 and through an associated cooling circuit (not shown) which may comprise a pump, a reservoir of cooling fluid and a heat exchanger. Heat generated by the engagement of the stators 24 with the disc 14 during the operation of the brake is transferred by thermal conduction to the cooling fluid and then dissipated through the cooling circuit.

It should be appreciated that the cooling fluid flowing through the fluid flow paths 32 is completely separate to the lubricating liquid held within the housing 10.

Now that an embodiment of the present invention have been described in detail it will be apparent to those skilled in the relevant arts that numerous modifications and variations may be made without departing from the basic inventive concepts. For example, the wet brake system may comprise a plurality of co-axially arranged discs 14 with intervening stators 24 where the discs 14 are slidably mounted but rotatably coupled to the hub whereby the pistons 34 are able to effectively press the stators 24 against the friction pads 22 of each of the discs 14. This in effect provides a multi-disc braking system. Further, the present embodiment depicts a pair of diametrically opposed pistons 34 acting on each stator 24. However a greater number of pistons may be provided for each shell 66 so as to act on the stators 24 at three or more spaced apart locations.

All such modifications and variations together with others that would be obvious to a person of ordinary skill in the art are deemed to be within the scope of the present invention the nature of which is to be determined from the above description.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A fluid cooled wet brake system comprising:
a sealed housing containing a lubricating liquid;
a disc disposed in the housing and adapted for fixing to a rotating body projecting into the housing, the disc having first and second opposite planar surfaces;
friction material attached to the first planar surface;
a first stator slidably mounted and rotationally fixed within the housing and having a first braking surface facing the first planar surface, the first stator provided with a fluid inlet, a fluid outlet, and one or more internal fluid flow paths extending between the fluid inlet and the fluid outlet through which a cooling fluid flows; and;
an actuator for selectively applying a force on the first stator to slide the first stator towards the disc and hold the braking surface against the friction material.

2. The wet brake system according to claim 1, further comprising a second stator having a second braking surface facing the second planar surface and wherein the friction material is attached to the second planar surface, with the second braking surface facing the friction material on the second planar surface, and wherein the actuator selectively applies force on the second stator to slide the second stator toward the disc and hold the second braking surface against the friction material on the second planar surface.

3. The wet brake system according to claim 1 wherein each stator is provided with a plurality of parallel fluid flow paths that extend between the fluid inlet and the fluid outlet.

4. The wet brake system according to claim 3 wherein each stator comprises a first annular plate provided with a plurality of channels on one side, and a second annular plate attached to the one side for covering the channels wherein the covered channels form the internal fluid flow paths.

5. The wet brake system according to claim 1, further comprising a mechanism that slidably couples each stator to the housing.

6. The wet brake system according to claim 1 wherein the friction material is in the form of one or more pads of friction material detachably coupled to the disc.

7. The wet brake system according to claim 6 wherein the pads are circumferentially spaced apart about the disc.

8. The wet brake system according to claim 6 wherein each pad is provided with grooves on its surface, where each groove opens at its opposite ends onto an edge of the pad.

9. The wet brake system according to claim 1 wherein the braking surfaces are provided with grooves which extend between, and open at their opposite ends, onto respective inner and outer edges of the braking surface.

10. The wet brake system according to claim 8 wherein the grooves follow a spiroidal curve.
